(19) United States
(12) Patent Application Publication
(10) Pub. No.: US 2004/0189448 A1
(43) Pub. Date: Sep. 30, 2004

(54) Video display for a vehicle environment surveillance unit

(76) Inventors: Helmuth Eggers, Ulm (DE); Gerhard Kurz, Wendlingen (DE); Juergen Seekircher, Ostfildern (DE); Thomas Wohlgemuth, Aichtal (DE)

Correspondence Address: Stephan A. Pendorf, Pendorf & Cutliff, 5111 Memorial Highway, Tampa, FL, 33634-7356, US

(21) Appl. No.: 10/807,720

(22) Filed: Mar. 24, 2004

(30) Foreign Application Priority Data
Mar. 24, 2003 (DE) 103 13 002.0-31

(51) Int. Cl. B60Q 1/00

(52) U.S. Cl. 340/425.5; 348/148

(57) ABSTRACT

A video image display (1) for a vehicle environment surveillance unit (0). The environment information is acquired by a camera (3) and processed into image information by a computer or processor (2). The produced image information is then displayed for the vehicle operator on a video image display (1). In order to be able to inform the vehicle operator regarding a malfunction (for example, a static image), acquired image information is stored in an intermediate memory (4). The most recently recorded image is then compared with the image information in intermediate memory using an image processing algorithm (5) and in the case that impermissible deviations are detected the displayed video image is modified or the video display is switched off. In the framework of the comparison of the image information, additional vehicle operating parameters (6) are taken into consideration, in order that a reliable check of the functioning of the video image display becomes possible. The system includes for this a supplemental warning means (7) independent of the video image display (1) which informs the vehicle operator of malfunctions.

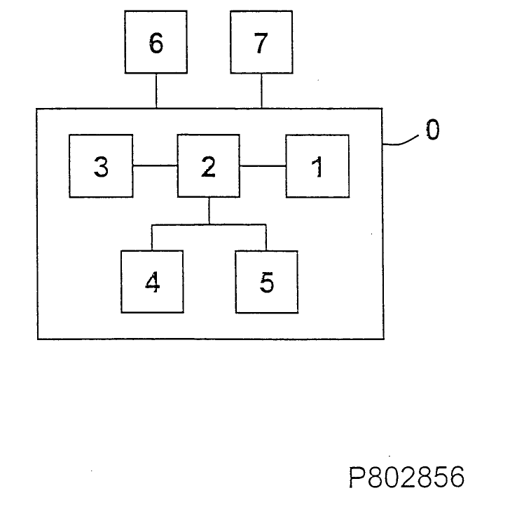

### BACKGROUND OF THE INVENTION

1. Field of Invention

The invention concerns a video display for a vehicle environment surveillance unit.

Modern vehicles are equipped with various operator assist systems, which are designed to support the vehicle operator. Included with increasing frequency among these are image-providing environment surveillance systems. In the field of automobiles there are, for example, night vision systems wherein the vehicle environment ahead of the vehicle is detected using an infrared sensor. The detected environmental data is processed into an image using a data processing unit and depicted upon a display, whereupon it can be accessed by the vehicle operator as needed.

2. Related Art of the Invention

In EP 1172665 A2 a system for observing the environment ahead of the vehicle is described. Included in this system is a microcomputer for identifying system malfunctions as they occur. The malfunction or error determination is based, in particular, upon the evaluation of luminance data of recorded images. For recording images two cameras are employed, which respectively register one view of the environment ahead of the vehicle. In the framework of error detection, first, the light intensity values of the recorded image data are calculated using a stereo image processing unit. Then, a microcomputer or microprocessor determines, on the basis of the calculated light intensity values, whether a system malfunction exists. In the case that a system defect has occurred, fail-safe precautions are taken.

In Japanese Patent Application JP 2001211466 A an image processing system for vehicle cameras is described. Individual images are taken by the vehicle camera of vehicles located in the environment of the vehicle, and video signals are generated therefrom. The image processing system includes a self-diagnostic unit. The functionality of the vehicle cameras is evaluated using this self-diagnostic unit. In the framework of the evaluation, individual images of the two vehicle cameras are compared with each other. Image processing processes are employed for this comparison, wherein processes such as optical flow or flux can be employed.

In Patent Application GB 2276790 A a tracking system for vehicles is described. The tracking system includes a camera by means of which images of a vehicle located in the environment are taken and therefrom, at a predetermined time interval, image signals are produced. The produced image signals are stored in a first image memory. A window setting circuit sets a chasing/tracking window on the stored image signals a predetermined time before, and a second memory stores, as reference image signals, the image signals on which the chasing window has been set. A disturbance detecting device detects whether or not any disturbance has been introduced into the image signals stored in the first memory. In the case that there are disturbances a correcting device corrects, by interpolation or similar technique, the image signals stored in the first memory to reduce the influence of any disturbance. A window updating device updates the chasing window in accordance with the result of comparison between the stored reference image signals and the stored image signals or, when a disturbance has been detected, in accordance with the result of comparison between the reference image signals and the image signals which have been corrected by the correcting means. The disadvantage with this system is, however, that during the display of image information the vehicle operator is not informed regarding functionality of the system.

### SUMMARY OF THE INVENTION

The present invention is thus concerned with the task of providing a new type of process for video image display for a vehicle environment surveillance unit, wherein a test of functionality is carried out.

This task is solved in accordance with the invention by a process having the characteristics of Patent Claim 1. Advantageous embodiments and further developments of the invention are set forth in the dependent claims.

According to the invention a video image display of the vehicle environment is generated or produced, wherein environment information is detected via at least one image sensor. According to the invention, the detected environment information is first processed into image information using a computer or processor. The processed image information is then displayed on a video image display, wherein this presented image information is additionally stored in an intermediate memory. The image information stored in the intermediate memory is compared with the most recent detected image on the basis of an image processing algorithm. In the case that, during the comparison of the most recent detected image and the image information stored in the intermediate memory, a determination is made that an impermissible deviation has occurred, the displayed video image is represented in modified form. In the framework of this invention a modification of the represented image is also understood to include a fade-out or a non-representation of the image. In inventive manner, in the framework of the comparison of the most recent detected image with the image information stored in the intermediate memory, additional vehicle operating parameters are taken into consideration.

Since vehicle operating parameters are taken into consideration, in a particularly preferred embodiment the image information processed with the vehicle environment unit can be subjected to a plausibility check. In the framework of this plausibility check, impermissible deviations between the most recently detected image and the image information stored in the intermediate memory are taken into consideration. For determining impermissible deviations, here the vehicle operating parameters are compared, in particular, with the detected image information or the image parameters of the image information. On the basis of a functionality test carried out by the plausibility check, it is now possible to inform the operator regarding the functionality of the vehicle environment unit.

In a preferred embodiment of the invention the operating parameter is a parameter which provides information regarding whether the vehicle is moving forwards or backwards or, as the case may be, is standing still. For this, there is provided, for example, a sensor which measures the direction of movement of the wheels. Here it is also conceivable that the direction of movement of the vehicle is measured on the basis of the movement of the vehicle axle or directly on the vehicle drive, for example, on the transmission. Using this movement information, the image information detected via the vehicle environment surveillance unit can be subjected to a plausibility check. For example, during the surveying of environmental data with a still-standing vehicle the view of the scene should not change. However, when surveying the environment with a still-standing vehicle the position and size of individual objects within a scene can change on the basis of their own movement. On the other hand, in the case that the own vehicle is in motion, image information can be detected, wherein both the view of the overall scene changes as well as the position and size of individual objects. The positioned and size of individual objects can change on the basis of their own and/or relative movement. The person of ordinary skill in the art of image processing is aware of processes with which, on the basis of detected image information, the own movement of the vehicle can be determined. If the detected data are compared with the actually measured values and there is agreement, then it may be presumed with a high level of confidence that the vehicle environment surveillance unit is functioning correctly.

In a further advantageous embodiment of the invention the operating parameter of the vehicle is the vehicle speed. Therewith, the functionality of the vehicle environment surveillance unit can be precisely checked. Therein, in particular, the image information is evaluated with respect to the change in the size and position of objects within a particular time frame. These objects could be, for example, trees, traffic signs or other vehicles. If, in addition thereto, the mapping or transformation parameter of the camera of the vehicle environment surveillance unit is known, then the speed of the own vehicle can be first estimated on the basis of the image information, and this can be subsequently compared with the vehicle measured speed. A person of ordinary skill in the art is familiar with various embodiments of speedometers for measuring the speed in vehicles.

In a particularly preferred embodiment, in the case of an impermissible deviation between the most recently registered image and the stored image information, a malfunction message is displayed on the video image display. For this, it is within the scope of the invention that, for generating the error message, text form or symbol form is selected. The error message can for example be superimposed over the environment image. Of course it is however also possible to present the background upon which the error message is represented in any possible color. For this, a means is envisioned whereby it is also possible to display a malfunction message in the case that the computer or processor or, as the case may be, the memory of the vehicle environment surveillance unit, is not functioning correctly or has no operating parameters for evaluation available to it. Preferably, for example, for varying causes of malfunction, various malfunction messages are stored in a reader-memory. These error or malfunction messages can be called up and presented as needed on the video display.

Besides this, it has also been found effective, in case an impermissible deviation of the most recently recorded or realized image from the stored image information, to automatically switch off the video image display. Therewith it can be avoided, for example, that erroneous image information is presented to the vehicle operator or that the vehicle operator inadvertently overlooks an error message on the video image display. Herein the switching off occurs in the manner that the video image display is completely switched off and can only be reactivated by the vehicle operator. Alternatively it is however also conceivable that, when the display is switched off, a standby mode is activated. The video image display in this case returns from standby operation and resumes display operation as soon as the impermissible deviation between the most recently recorded image and the stored image information no longer exists. Herein it is also conceivable that other vehicle systems can use the video image display during the standby operation.

Preferably, for correction of the displayed video image, a resumed image recording is activated or initiated and the newly recorded images replace the most recently recorded image. A renewed image recording is particularly advantageous in the case that short-duration impermissible deviations are present in the image information, for example in the case that the view of the camera is covered for a short period. This could occur for example when a bird, or foliage falling from trees, passes close before the lens of the camera. In this case a fixed, predetermined number of new image recordings is permitted.

In the case that, following a fixed predetermined number of new image recordings, an impermissible deviation of the image information continues to be present or, as the case may be, that a renewed initiation of the image recording is not possible, then an error message is displayed on the video image display. The type and manner of the error message which is to be displayed upon the video image display has already been described above. At the same time it is conceivable that in the case of a renewed initiation of image recording is not possible, that the video image display is automatically switched off. The type and manner of the switching off of the video image display occurring thereby has already been described above.

In a further advantageous embodiment the vehicle operator is informed of an impermissible deviation between the most recently recorded image and the stored image information by means independent of the video image display. For this a warning means is provided which is in communication with the vehicle environment surveillance unit. Information regarding impermissible deviations are, in this case, immediately relayed to this type of warning means. The user is then warned of the malfunction of the video image display, even if he does not look directly at the video image display or, as the case may be, that due to environmental conditions the display is difficult to read. In a further advantageous manner optical signals are used for providing information to the operator, in which case an optical display means is provided as warning means. This could be a simple indicator light, which is preferably located in the field of view of the vehicle operator, for example in the dashboard of the vehicle. Of course it could however also be any other known variation of an optical display means suitable for vehicles. Special color assignments and, for example, special blinking frequencies are conceivable in the operation of the display light. The optical warning means in this case remain activated until the impermissible deviation between the most recently recorded image and the stored image information is no longer present. Of course, it is however also conceivable that the optical warning means remains activated until an acknowledgement is made by the vehicle operator.

It is however also conceivable that acoustic signals are used for informing regarding deviation between the most recently recorded image and the stored image information, wherein an acoustic output means is employed as the warning means. Herein various forms such as, for example, a spoken message or a warning tone are conceivable as the information provider. This acoustic output means can, in particular, be for example a loudspeaker or a buzzer. This type of acoustic warning means could be incorporated at various locations within the internal space of the vehicle or could be integrated into already existing vehicle acoustic systems. The acoustic warning means in this case remains activated until the impermissible deviation between the most recently recorded image and the stored image information no longer exists. It is of course also conceivable that the acoustic warning means remains activated until an acknowledgement by the user occurs.

The invention can be employed in a vehicle environment surveillance system, and in particular in association with a night vision system. Night vision systems are preferably employed for early recognition of objects in poor visibility (for example, other traffic participants). Thereby it is made possible for the vehicle operator using the system to look out a further distance. The representation could involve a dark background and light object representation. Here, however, the position of objects which are located a great distance from the vehicle change by only a few pixels in the video image display. For this reason it is generally difficult for the vehicle operator in such situations to recognize whether the video image display is correctly functioning or whether a malfunction has occurred and, for example, despite vehicle movement, a static image is being displayed. In the case that a static image is being displayed, those objects of critical interest to the vehicle operator, such as other traffic participants or suddenly occurring obstacles, are no longer displayed.

The invention could also be employed in a vehicle environment surveillance system which is designed in particular for searching for a parking place. This type of system works with an image recording unit which is sensitive in the visible spectrum and displays to the vehicle operator, on a video image display inside the vehicle, the scene of the parking space or clearance. Here the vehicle operator, in contrast to the situation when using a night vision system, is not looking into the distance but rather the immediate vicinity of the vehicle. Since the close-in search for park place however conventionally occurs while driving slowly, it is particularly difficult for the vehicle operator to distinguish the display of a static image from the moving image display. In the case that a static image begins shortly before an obstacle, then the vehicle operator only has a short time to react thereto. Often a collision can in this case no longer be avoided.

### DETAILED DESCRIPTION OF THE INVENTION

The figure shows an example of a schematic configuration or layout of the inventive video image display 1 of a vehicle environment surveillance unit 0. For this, the vehicle environment surveillance unit 0 includes an image sensor 3, by means of which environment information is obtained. The detected environment information is processed into image information via the computer or processor unit 2 and is displayed upon the video image display 1. In addition, the image information is stored in an intermediate memory 4. The most recently recorded image is compared with the image information stored in the intermediate memory 4 using an image processing algorithm 5. In the framework of the comparison, supplemental vehicle operating parameters 6 are taken into consideration. Herein, in the case of an impermissible deviation of the most recently recorded image from the stored image information, the display video image is modified. Besides this, the vehicle operator is warned by means of a warning means 7 in the case of this type impermissible deviation, which warning means is in communication with the vehicle environment surveillance unit 0.

### Reference Number List

0 vehicle environment surveillance unit

1 video image display

2 computer

3 image sensor

4 intermediate memory

5 image processing algorithm

6 operating parameters

7 warning means

In the claims:

1-13. (Cancelled)

14. A video display system for a vehicle environment surveillance unit (0), including
a video display (1),
at least one image sensor (3) for acquisition of environmental information,
a computer or processor (2) processing the acquired environment information into image information and displaying the results on the video display (1),
an intermediate memory (4) into which the image information is additionally recorded, and
comparison means including an image processing algorithm (5) via which the most recently recorded image is compared with the image information stored in intermediate memory and triggering a modification of the displayed video image on detecting an impermissible deviation between the most recently recorded image and the image information in the intermediate memory,
wherein, during comparison of the most recently recorded image with the image information in memory, vehicle operating parameters (6) are additionally taken into consideration.

15. A video image display system according to claim 14, wherein the operating parameter (6) is a parameter which provides information regarding whether the vehicle is moving forwards or backwards or standing still.

16. A video image display system according to claim 14, wherein the operating parameter (6) is the vehicle speed.

17. A video image display system according to claim 14, wherein, in the case of an impermissible deviation between the most recently recorded image and the image information in memory, an error message is displayed on the video display (1).

18. A video image display system according to claim 14, wherein, in the case of an impermissible deviation between the most recently recorded image and the image information in memory, the video image display (1) is automatically switched off.

19. A video image display system according to claim 14, wherein for correction of the displayed video image a new image is acquired and the newly acquired image replaces the most recently recorded image.

20. A video image display system according to claim 14, wherein in the case that a re-initiation of the image recording is no longer possible, an error message is displayed on the video image display (1).

21. A video image display system according to claim 14, wherein in the case that a re-initiation of the image display is no longer possible, the video image display (1) is automatically switched off.

22. A video image display system according to claim 14, wherein the vehicle operator is informed regarding an impermissible deviation between the most recently recorded image and the image information in memory by a means independently of the video image display (1), which independent means is in communication with the vehicle environment surveillance unit (0).

23. A video image display system according to claim 22, wherein an optical display means is used as the warning means (7) providing optical signals for informing the vehicle operator.

24. A video image display system according to claim 22, wherein an acoustic output means is provided as the warning means (7), providing acoustic signals for informing the vehicle operator.

25. A video image display system according to claim 14, wherein said vehicle environment surveillance system (0) is a night vision system.

26. A video image display system according to claim 14, wherein said vehicle environment surveillance system (0) is a system for locating a parking place.

27. A method for displaying image information for a vehicle environment surveillance unit (0), said method comprising:
acquiring environmental information using at least one image sensor (3),
processing the acquired environment information with a computer or processor (2) into image information,
displaying the processed image information on a video display (1),
separately, storing the processed image information in an intermediate memory (4), and
comparing the most recently recorded image with the image information stored in intermediate memory using an image processing algorithm (5),
triggering a modification of the displayed video image on detecting an impermissible deviation between the most recently recorded image and the image information in the intermediate memory,
wherein, during comparison of the most recently recorded image with the image information in memory, vehicle operating parameters (6) are additionally taken into consideration.

28. A method according to claim 27, wherein said vehicle environment surveillance system (0) is a night vision system.

29. A method according to claim 27, wherein said vehicle environment surveillance system (0) is a system for locating a parking place.
